(19) United States
(12) Patent Application Publication
(10) Pub. No.: US 2002/0157258 A1
(43) Pub. Date: Oct. 31, 2002

(54) Bikini TM blade apparatus and methods

(76) Inventor: Kathleen A. Curran, Rochester, NY (US)

Correspondence Address: PATENT LAW FIRM, P.C., 26892 Preciados, 2nd Floor, Mission Viejo, CA, 92614, US

(21) Appl. No.: 09/847,454

(22) Filed: May 2, 2001

Related U.S. Application Data
(60) Provisional application No. 60/201,432, filed on May 3, 2000.

(51) Int. Cl. B26B 21/14

(52) U.S. Cl. 30/50

(57) ABSTRACT

Bikini™ Blade apparatus for reducing levels of visible hair present within the bikini line region, or the groin area of a user, is made up of at least a blade in a razor blader head assembly, which is otherwise conventional, except for having a cutting edge ranging from at least about 0.50 inches to about 0.90 inches, in combination with conventional attachments, handles and refillable and disposable specialized handle structures, with which it is compatible. A method of use and kit are likewise disclosed whereby at least one of a user's groin area and bikini line are rendered substantially free of visible hairs.

### CROSS-REFERENCE TO RELATED APPLICATIONS

The present invention is based upon U.S. provisional application No. 60/201432, filed May 3, 2000 by the present inventor, full Paris Convention priority is claimed, and said priority document is expressly incorporated by reference as if the same was fully set forth herein.

### BACKGROUND OF THE INVENTION

The present invention relates to novel enhanced shaving means for grooming specific areas of animals, and preferably humans. In particular, the present invention relates to scaled down razor means for shaving pubic areas having heightened angular and spatial constraints, preferably of women.

Attention is called to United States Letters Patents:

| | | | | | |
|---|---|---|---|---|---|
| 4,379,219; | 4,488,357; | 4,492,024; | 4,498,235; | 4,551,916; | 4,573,266; |
| 4,586,255; | 4,587,729; | 4,621,424; | 4,709,476; | 4,742,909; | 4,756,082; |
| 4,807,401; | 4,916,817; | 5,063,667; | 5,113,585; | 5,157,835; | 5,192,712; |
| 5,249,361; | 5,399,204; | 5,578,114; | 5,687,485; | 5,800,627; | D306,216; |
| D312,568; | D316,962; | D349,242; | D363,142; | D370,844; | D373,444; |

and D381,121; each of which was examined and found to be different from the instant teachings.

### SETTING OF THE INVENTION

Many women wish to sport undergarments and swimware in a fashion that displays or shows no visible signs of hair growth within the zone defined by the intersection of the boundaries of these undergarments or swimware and their own growth of pubic hair, often referred to as the “bikini line.”

Likewise, those who desire a smooth, stubble free, and unblemished surface within the pubic area itself have had little resort to possible solutions outside of dilapitory ( for example, NAIR® brand of hair removal products) or trimming based attempts ( eg. LADIBIKINI® by EPILADY)both of which are sorely lacking, in terms of efficacy, result and convenience.

In short, the problem of shaving the ‘bikini line’ (defined for the purposes of the instant application for U.S. Letters Patent as areas of pubic hair within that region extending at least about from the dual vertices of the inverted triangular zone beginning proximate to each of the respective pubic bones, which demarcate the groin area, through and in between the legs until the distal edge or apex of the triangular zone within an individually predetermined space location in the fold of skin defined by the buttocks) has never been squarely addressed and remains a longstanding need for those who wish to prevent visibility of pubic hair outside of clothing or from existing at all on the ‘mons pubis’, or related areas on men.

It is well known that certain areas of humans are susceptible to the development of hair. Razor blades and handles for the same were first developed for the facial areas and heads of men. Conventional or standard razor blades are at least about 1.5 inches long, with only width values being varied to date. It is understood that the instant teachings apply equally to single, double, treble or any conventional variation on the number of blades stored in a blade head, as the same is known.

Traditionally, hair growth in females has been treated by methods varying from wax to radical allopathic laser based or even more extreme treatment regimens or radical medical intervention. This approach is risky for those involved. More recently there have been a number of proposals for the customization of shaving equipment for women. However, such design improvements have ostensively been limited to handles and color stories.

Difficulties arise in the placement of a straight edged razor blade across body zones having lesser planar components. For example, the bikini line is often not cleanly shaved enough to prevent unwanted extensions of pubic hair outside of the surface coverage of undergarments or swimwear, as discussed above.

Standard razor blades have evolved over the years into designs purported to address the needs of women. However, this ‘evolution’ ostensively is less concerned with technical issues than with packaging and marketing concerns. For example, changes in razor handle and colors (mostly Pastel-based) have yet to impact upon the basic constraint of the conventional size of the razor head, which has remained at least about one and one-half inches.

Feminine shaving products adhering to the standard or safety razor designs and sizes of the day seem to be directed at aspects of a woman's body other than the bikini line area. This large area of focus includes both the legs and underarms, which are separate matters entirely. Likewise, alternate means have proven to have drawbacks since creams, jells, and electronic solutions have not proven sufficient for most women to date, there remains a strong demand and extreme need for the teachings of the present invention.

In order to address the clearly longstanding need of providing a means for safely and effectively removing hair from a woman's bikini line, the instant teachings are herewith offered for consideration and believed to constitute a modicum of progress in the pursuit of science and the useful arts on such basis.

### OBJECTIVES AND SUMMARY OF THE INVENTION

Accordingly, it is an object of the present invention to provide a compacted razor head.

Another objective is to provide a shaving apparatus having a blade length smaller than the conventional standard safety razor size for shaving a bikini line or groin area more precisely.

Still another objective is to provide a razor means that fits more easily and comfortably within the constraints of shaving a woman's bikini line, or the pubic area of either sex, which is compatible with conventional handles, blade guards, and related cutting edge shaving accoutrements.

These and still further objectives are defined in the claims appended hereto, whereby the teachings of the present invention are differentiated from conventional technology.

The foregoing objectives are achieved in apparatus for reducing levels of visible hair present within the bikini line region which includes a blade means for cutting, ranging from at least about half of an inch to nine-tenths of an inch, effective for use with any ergonomic, or known handle member for closely adhering to a predetermined spatial orientation, wherein a surface area of the blade means and the handle are preferably in a predetermined ratio or from at least about 5.1 to about 1.0 units of surface area.

Briefly stated, Bikini™ Blade apparatus for reducing levels of visible hair present within the bikini line region, or the groin area of a user, is made up of a blade having a cutting edge ranging from at least about 0.60 inches to about 0.90 inches, in combination with conventional attachment, handle and refillable and disposable specialized handle structures, with which it is compatible. A method of use and kit are likewise disclosed.

According to a feature of the present invention there is provided a kit, which comprises, a razor blade defined by a cutting edge having length of between about 0.60 and about 0.90 inches, a means for attaching the razor blade to a handle member and, a handle member.

Likewise, a method of using a bikini™ blade includes the steps of providing a blade measuring from about 0.6 to 0.9 inches and preferably between about 0.75 and 0.83 inches, and utilizing the same at a predetermined spatial angle in relation to a user's skin to remove hair from an area of the user's skin.

Similarly, a method of making a bikini™ blade comprises providing a miniaturized blade as previously defined, having a fixed dimensional proportion in relation to a handle, and combining the same with a handle to form an integral unit.

Finally, a kit includes a bikini™ blade, as defined above, and a means for fixedly attaching the same to a handle member, and the handle member itself, and with conventional specialty handles that are effective for releasing shaving cream or disposable, blade guards, and related cutting edge shaving accoutrements.

### BRIEF DESCRIPTION OF THE DRAWINGS

FIG. 1 is a schematized illustration of an exemplary bikini™ blade type of blade member, according to the teachings of the present invention, in a top or plan view;

FIG. 2A is a schematized illustration of another bikini™ blade type of blade featured with a blade enclosure adapted to be used with the instant teachings, with;

FIG. 2B being a refillable razor handle means using conventional click-on technology for mounting a bikini™ blade type of blade according to the teachings of the present invention; and,

FIG. 3A, 3B and 3C each being a schematic of a bikini™ blade type of blade in conjunction with a disposable type of conventional razor handle assembly.

### DETAILED DESCRIPTION OF THE INVENTION

The present inventor has discovered that in seeking enhanced precision in razor based hair removal, a smaller and narrower razor head likewise brings the unexpected benefit of nonencroachment upon critical non-hair growing regions (such as the greater labial zone, or area of a women's body that is centered between the two narrow hair-growing passages running from the frontal region of the pubic hair through the legs towards the buttocks). To these ends, an appropriately sized and fitted shaving device is an asset for specific hair removal needs in the bikini line area, and likewise may assist with related difficulty angled shaving zones. Similarly, by providing a compacted razor blade a customized shaving apparatus for special needs has been developed without the need for specialized handles or the like means which compromise the mechanical integrity of the shaving system.

According to the teachings of the present invention, the present inventor has discovered that a razor blade that has a smaller blade length, for example, at least about 0.60 inches, in comparison to the standard or conventional razor blade length (1.5 inches) more easily and comfortably fits into, and removes unwanted hair from, a woman's bikini line area, inter alia.

As detailed above, the driving force behind the instant discovery is the fact that the bikini line area of a woman's body encompasses areas smaller than the width of a conventional razor, and invention resulted because a smaller and more spatially compact razor blade means, in combination with conventional technology for enclosure and mounting, addresses this longstanding need, while imparting significant related benefits inherent in the novel, nonobvious and new design of the present invention.

In order to remove unwanted hair from a woman's bikini line the instant teachings were developed and the improved shaving system engendered by solving this problem is herewith offered for consideration. As defined herein, ‘razor head’ comprises conventional blade razor blade housing and/or mounting technology, such that applicant's novel miniaturized blade configuration is positioned to shave a user. Likewise ‘blade’ is used interchangeably with the instant term herein.

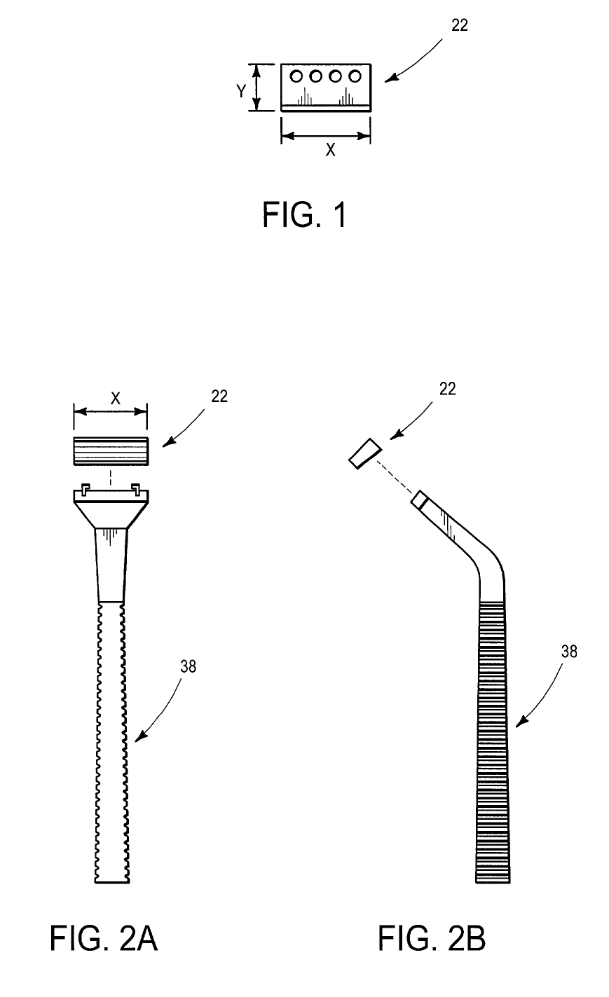

Referring now to FIG. 1, bikini™ blade type of blade 22, which is effective for use with known razor heads, is constructed of conventional materials, including known metals or alloys, Shape Memory Alloys (SMAs) and the like and is preferentially defined by a set of dimensional requirements, whereby a predetermined ratio of length X to width Y is maintained.

For example, according to preferred embodiments, blade 22 is between about 0.60 inches and 0.90 inches in length in preferred embodiments, as a measurement of the X dimension. While Y is able to be gauged at least about 0.4375 inches, similar to conventional razor blades.

Blade 22 is effectively housed in conventional protective and storing razor blade enclosures (not shown) which generally span no more than 0.0625 of an inch in width and do not exceed to overall blade enclosure length of 0.4375 inches. Top and bottom housings are known (thus not shown), and for example with blade 22 of the instant invention, bottom housings and protective strips likewise would adhere to the standard 0.0625 inch width and the overall razor head length of 0.90 inches. Similarly, the top housing and protective blade strip (not shown) do not exceed the overall razor blade head length of 0.90 inches and may be up to 0.25 of an inch to incorporate lubricating strips (also known and not shown).

FIG. 2A and 2B each shows blade 22, in combination with handle 38, which may be angled as illustrated to craft a desired pubic hair line along the bikini line of a woman. Refillable handle technology which works with the instant teachings is known, for example, from the GILLETTE COMPANY (Boston, Mass. 02199), as is the click-on technology for mounting blade 22 in a razor cartridge, onto handle 38.

To craft a desired pubic hair line, handle 38 is grasped by user and blade 22 used to navigate narrow passages to eliminate unwanted pubic hair extending outside of the bikini line, and/or remove hair within said zone by controlled and pressured placement along the surface of user's skin, whereby each hair follicle is extended from is existing obtuse angle until sliced by blade 22, as known to those skilled in the art of shaving, and enjoyed by any shavers using standard technology.

Blade 22 is manoeuvred easily along the user's bikini line owing to the novel enhanced blade length (X). Unwanted hair is thus able to be accessed and removed without the danger of having the extra blade length impact the delicate skin of the user, and tear, perforate or otherwise insult the same.

Handle 38, and blade 22 function with known technology for elimination or minimization of shaving injuries, or ‘nicks’ including but not limited to lubricated strips, and protective blade strips made by the GILLETTE COMPANY (Boston, Mass. 02199), as well as the know refillable cartridge-type of handle also made by the same company, inter alia.

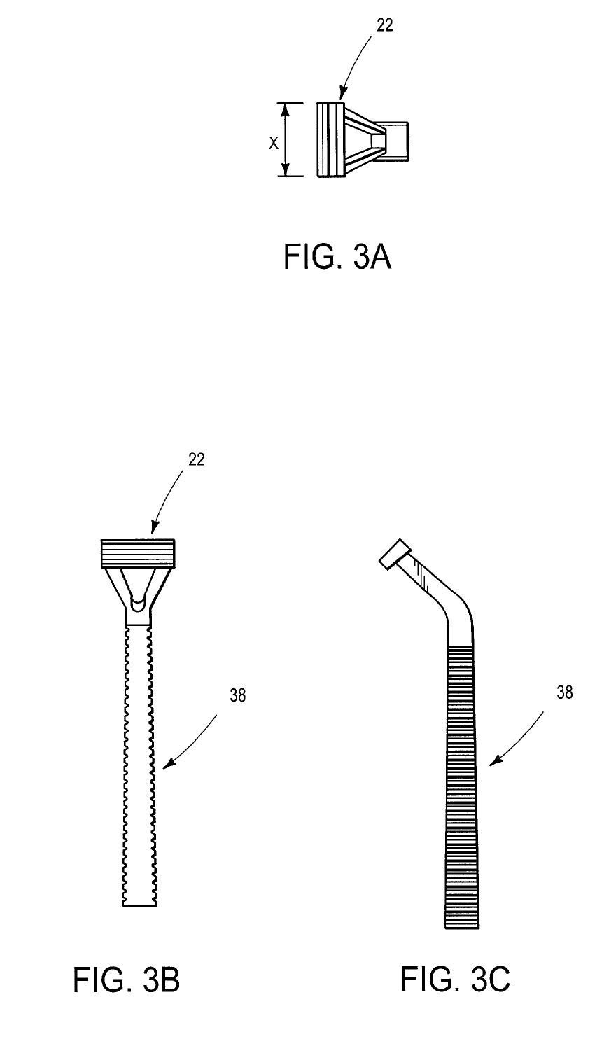

FIG. 3A, 3B and 3C each shows a disposable model incorporating blade 22, and handle 38 which may have known tapers, angulation, or variations upon the same, and be made of disposable, reconstituted, recycled or any known plastics as is well known, for example, as available from the GILLETTE COMPANY (Boston, Mass. 02199). Blade 22, is used at a length X of between about 0.60 and 0.90 inches. As defined above, blade 22 is housed conventionally forming razor heads with known means.

Since a blade of between about 0.60 and 0.90 results in a razor head which more naturally, comfortably and safely can be angled to shave the bikini line area, it likewise better services the narrow hair growing passages that run between women's legs toward the buttocks. When removing unwanted hair from such uniquely feminine and delicate skin areas, it is imperative to use extreme caution so as not to expose non-hair growing regions to the cutting edges of the razor head.

A smaller and narrower razor head likewise brings the unexpected benefit of nonencroachment upon critical non-hair growing regions (such as the greater labial zone, or area of a woman's body that is centered between the two narrow hair-growing passages running from the frontal region of the pubic hair through the leg towards the buttocks) which is essential in the event that a woman elects manual hair-removal. Since creams, jells, and electronic solutions have not proven sufficient for most woman to date, there remains a longstanding need for the teachings of the present invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

In the claims:

1. A Bikini™ Blade apparatus for reducing levels of visible hair present within the bikini line region, or the groin area of a user, comprising, in combination:
at least a blade means for cutting, disposed in a razor blade head assembly in predetermined angled spaced relationship to;
a handle member;
wherein the blade means is defined by a length of between about 0.60 and about 0.90 inches.

2. Apparatus as defined in claim 1, wherein the handle member is refillable and dispenses shaving cream.

3. Apparatus as defined in claim 1, wherein the handle member is readily detachable from the razor blade head assembly, and the handle member is disposable.

4. Apparatus as defined in claim 1, said at least a blade means is a unitary metallic member having a width of at least about 0.4375 inches.

5. Apparatus as defined in claim 1, said at least a blade means is razor blade having a length of at least about 0.70 inches.

6. Apparatus as defined in claim 4, said at least a blade means is razor blade having a length of at least about 0.70 inches.

7. Apparatus as defined in claim 1, said least a blade means is razor blade having a length of at least about 0.75 inches.

8. Apparatus as defined in claim 4, said at least a blade means is razor blade having a length of at least about 0.75 inches.

9. Apparatus as defined in claim 1, said at least a blade means is razor blade having a length of at least about 0.80 inches.

10. Apparatus as defined in claim 4, said at least a blade means is razor blade having a length of at least about 0.80 inches.

11. Apparatus as defined in claim 1, said at least a blade means is razor blade having a length of at least about 0.85 inches.

12. Apparatus as defined in claim 4, said at least a blade means is razor blade having a length of at least about 0.85 inches.

13. Apparatus as defined in claim 1, said at least a blade means is razor blade having a length of at least about 0.90 inches.

14. Apparatus as defined in claim 4, said at least a blade means is razor blade having a length of at least about 0.90 inches.

15. A Method For Removing Unwanted Hair from the bikini line area, comprising the steps of:
providing a razor head assembly including at least a blade defined by a length of between about 0.60 and about 0.90 inches for its cutting edge;
attaching the razor head assembly to a handle member to create a completed razor assembly;
passing the completed razor assembly along a predetermined pathway to remove hair;
repeating the passing step, as needed, until the unwanted hair has been removed.

16. A kit, comprising:
a razor blade head assembly defined by a cutting edge having length of between about 0.60 and about 0.90 inches;
a means for attaching the razor blade head assembly to a handle member; and,
a handle member.

17. Kit, according to claim 16, further comprising:
a refillable cartridge based system for dispensing shaving cream.

18. Kit, according to claim 16, further comprising:
a disposable handle member fixedly attached to the razor blade head assembly.

19. Kit, according to claim 16, further comprising:
pivoting means for enabling a user to manoeuvre within the limited confines of a groin area, whereby a user's bikline line may be effectively stripped of unwanted or visible hairs.

20. Method, according to claim 15, said razor blade head assembly is compatible with conventional shaving systems, further comprising at least one of refillable, disposable, and standard handle means for receiving a razor head.
